(19) United States
(12) Patent Application Publication
(10) Pub. No.: US 2013/0055644 A1
(43) Pub. Date: Mar. 7, 2013

(54) Thermoplastic Reinforcement for a Profiled Seal or Profiled Molding in a Motor Vehicle, Profile Element Comprising the Same, and Method for the Production of Reinforcements

(71) Applicants: Sylvain Baratin, Corquilleroy (FR); Philippe Chapeau, La Cour Marigny (FR); Olivier Blottiau, Cepoy (FR)

(72) Inventors: Sylvain Baratin, Corquilleroy (FR); Philippe Chapeau, La Cour Marigny (FR); Olivier Blottiau, Cepoy (FR)

(73) Assignee: HUTCHINSON, Paris (FR)

(21) Appl. No.: 13/575,449

(22) PCT Filed: May 20, 2011
(86) PCT No.: PCT/IB2011/052219

§ 371 Date: Sep. 14, 2012

(30) Foreign Application Priority Data
May 20, 2010 (FR) 10 02129

(51) Int. Cl. E06B 7/16; B29C 47/00

(52) U.S. Cl. 49/490.1; 264/177.1

(57) ABSTRACT

The invention relates to a bendable thermoplastic reinforcement for a profiled seal or profiled molding in a motor vehicle, such a profiled element comprising the reinforcement, and a method for producing thermoplastic reinforcements, including those of the invention. The reinforcement includes at least one longitudinal section having a substantially U-shaped or L-shaped cross-section and includes a top and at least one leg extending from said top. Along its length, the reinforcement has a non-continuous series of transverse portions joined to each other by longitudinal connecting elements. The connecting elements have a generally longitudinal rib structure integral with the transverse portions in the leg/s and is designed to form a neutral fiber for the profiled element.

The present invention relates to a bendable thermoplastic reinforcement, in particular for a profiled seal or profiled trim molding in a motor vehicle, such a profiled element comprising the reinforcement, and a method for the production of bendable thermoplastic reinforcements, generally including those of the invention by way of non-limiting example. The invention relates, in particular, to such profiled elements which are capable of being fixed to a frame rebate and which form lateral or front/rear opening seals for motor vehicles of the tourism, utility or heavy goods type, such as for example side door entry seals, seals for the trunk, tailgate or swinging rear door, hood seals, glass run channel seals possibly of the internal semi-sliding type, single-rebate type or “truck style” type, double sealing gaskets, rear wheel housing seals or dirt-resistant seals.

Generally, profiled seals for motor vehicle door openings comprise a retaining zone such as a U-shaped grip, on a rebate receiving a frame, with additionally in some cases a flexible and deformable adjacent part making it possible to ensure the seal at all points between the opening and the door frame of the bodywork, for example. Said profiles essentially have to meet the following requirements:
retention by clamping onto the rebate and resistance to stresses capable of causing tearing or “unhooking” relative to said rebate;
flexibility to follow the often complex shape of the mounting perimeter, with more or less small radii of curvature and to facilitate the packaging thereof;
stability of the grip on the rebate to prevent the tilting thereof (and potentially the loss of sealed contact) or excessive deformation of the sealed zone which depends, in particular, on the positioning of the neutral axis of the profiled element (i.e. of its imaginary longitudinal line or plane not having any deformation of the compression type or any extension when said profiled element follows a radius);
facility for mounting or “hooking” onto the rebate;
low weight to assist with reducing the weight of the vehicle;
low manufacturing cost and, preferably, recyclability.

Said known profiled seals incorporate a flexible reinforcement which is generally a metal reinforcement having cutouts with or without the removal of material, obtained mechanically for example by forming slots or sawing, by cutting or drawing, or even by punching a flat metal plate to obtain the desired patterns. Said reinforcement is then usually covered by the extrusion of an elastomeric coating to ensure a good grip on the rebate and, if required, the seal between an opening and a door frame of the bodywork or between a sheet metal element and a glazed unit of said door.

The document U.S. Pat. No. 6,079,160 discloses such a profiled seal of which the U-shaped metal reinforcement reinforcing the grip is notched and also provided on one of its two limbs with a continuous longitudinal strip provided to define the neutral axis of the profiled element.

Despite controlling the neutral axis which may be ensured in this manner, said metal reinforcements have the major drawback of being relatively heavy, costly to manufacture and not recyclable at the same time as the remainder of the profiled element (due to the requirement of separating the metal and non-metal materials before exploiting them) which involves an additional recycling cost.

This is why for a number of years it has been desirable to produce said flexible reinforcements in a thermoplastic material, by forming for example slots in a planar blank reinforcement by calendering, then coating and then shaping said blank to obtain the U-shaped grip of the profiled element, as shown in the document US-B2-7 135 216. Thus a reinforcement which is recyclable and of reduced weight is obtained, but which has the major drawback that the neutral axis of the profiled element is not controlled as the arms of the U-shaped grip obtained have the tendency to open over time, due to the memory effect of the material.

Also disclosed in the document EP-B1-1 093 902 in the name of the applicant is a method for manufacturing a thermoplastic reinforcement for profiled seals of which the definitive section, for example U-shaped with a top portion and two arms, is directly obtained by calendering, to obtain in each arm a series of limbs separated by slots as a result of calendering (i.e. without a post-forming operation). To this end, the thermoplastic material designed to form the reinforcement is passed between an engraved male wheel along a hollow cavity (i.e. defining the “negative” shape of the profiled reinforcement to be obtained) and a female wheel which tangentially covers said male wheel and which is driven in synchronous co-rotation therewith.

A reinforcement thus calendered without post-forming provides satisfactory results, in particular, in terms of the flexibility of the profiled seal incorporating said reinforcement on the perimeter of the rebate receiving said seal. However, experience has shown that said calendered reinforcement does not always make it possible to confer to the profiled element sufficient clamping values for being held on the rebate, in contrast to a profiled element with a metal reinforcement.

Within the context of research, the applicant has sought to provide by this calendering method such a U-shaped reinforcement with a longitudinal neutral axis, in order to improve further the seal obtained at any point of the perimeter of the rebate with regard to water, air and dust ingress into the vehicle in all positions of the opening (for example, taking account of the manufacturing tolerances of the different components and mounting clearances). More specifically, tests carried out by the applicant have shown that this calendering method only permits such a neutral axis to be formed on the top portion of the U-shape of the reinforcement (i.e. in a zone tangential to the calendering wheels, due to their relative rotational movement) and experience has shown that this neutral axis at the top portion for the reinforcement is not able to eliminate the risk of tilting of the profiled grip with the creation of specific radii of curvature on the rebate, thus potentially causing a loss of sealed contact and the risk of water, air and/or dust ingress between said rebate and said profile.

An object of the present invention is to propose a bendable thermoplastic reinforcement for a profiled seal or profiled molding in a motor vehicle, the reinforcement comprising at least one longitudinal portion of substantially U-shaped or L-shaped cross section having a top portion or base and at least one limb extending from said top portion, said reinforcement comprising over its length a discontinuous series of transverse sections connected together by longitudinal connecting elements, which remedies the aforementioned drawbacks by having at least one longitudinal neutral axis which is able to be positioned in a variable manner and which is adjustable in various positions of the reinforcement without being limited to a predetermined zone thereof such as its top portion, in the case where said portion is U-shaped.

This object is achieved in that the applicant has surprisingly discovered that if at least one thermoplastic material designed to form the reinforcement is extruded via a die formed between an extruder head and a receiving member for the material discharged from said head, which is provided with a hollow cavity designed to form directly said top portion and said at least one limb of said or each portion, so that said material thus extruded gradually covers said receiving member, it is possible, in particular, to obtain directly by this particular extrusion and after separation of said material from this member, a reinforcement according to the invention in which said connecting elements comprise a generally longitudinal rib which is formed in one piece with said transverse sections in said or each limb and which is designed to form a neutral axis for the profiled seal or molding.

By the expression “at least one longitudinal portion of substantially U-shaped or L-shaped cross section” is understood a reinforcement which is able to comprise a combination of one or more portions of U-shaped section and/or one or more portions of L-shaped section, and specifically that the top portion or base of the U or L-shape may equally be flat or rounded.

According to a further feature of the invention, said reinforcement according to the invention, which thus may be exclusively extruded, is such that said or each rib is directly extruded.

It is noteworthy that a reinforcement according to the invention thus has the advantage of being compatible with both positive and negative radii of curvature of a U-shaped profiled element incorporating said reinforcement (by “positive and negative radii” reference is made in the known manner to bends produced on both sides of a plane parallel to the top portion of the U-shape and perpendicular to said top portion, respectively), as is the case in particular for profiled elements forming door entry seals. In particular and as explained below, said extrusion method according to the invention permits in the case of a reinforcement of U-shaped section to adjust at will the shape and positioning of the neutral axis on the two limbs of the U-shape and not on the top portion thereof, in contrast to the aforementioned calendering method which in combination with the slots separating said transverse portions, thus improves the stability of the grip of the profiled element on the rebate by minimizing its risk of tilting and thus loss of sealed contact on said rebate at all points of the perimeter thereof.

According to a further feature of the invention, said transverse sections may be separated in pairs from one another by transverse spaces passing from one free lateral edge to the other of the reinforcement and may be exclusively connected to one another by said or each rib and, at said top portion of said at least one longitudinal portion, said transverse sections may not be connected together (i.e. they are independent) or may be connected via inserts of reduced thickness in the manner of the webs disclosed in the aforementioned document EP-B1-1 093 902.

It is noteworthy that the formation of said transverse separating spaces, in the case where said at least one longitudinal portion is of U-shaped section, excludes any staggered arrangement of said transverse sections on the two limbs of the U-shape.

Preferably, said transverse sections which are in series in said at least one longitudinal portion are identical (like said transverse spaces), specifically in that they could locally be of different geometries by being separated by transverse spaces which are also different.

According to a further feature of the invention, said or each rib may extend continuously along said transverse sections, such that on said at least one limb only one ordinate transverse to said rib corresponds to one given longitudinal abscissa of said rib (i.e. an “altitude” relative to said corresponding top portion). In other words, said or each rib is exempt of return portions over its length, thus extending continuously in the direction of one end of the reinforcement.

According to an exemplary embodiment of the invention, said or each rib is rectilinear or in the form of a broken line and is substantially parallel with said top portion or inclined relative thereto. As a variant, said or each rib may be curved, either by being progressively inclined toward said top portion or undulated by alternately moving away and then approaching said top portion (for example in the manner of a sinusoid).

Advantageously, as said at least one limb has an internal face and an external face (by definition respectively facing and opposing said top portion), a reinforcement according to the invention may be such that said or each rib forms an overthickness on said internal or external face (i.e. on one or other of the two faces of the limb) of reduced transverse height relative to that of said limb.

Preferably, said or each rib is hollow over its length, an anti-elongation thread (e.g. of glass fibers, polyamide such as “nylon”, copper or even any other suitable material) being inserted therein to stiffen the reinforcement in the longitudinal direction.

According to a further optional feature of the invention, said at least one limb, over at least one part of the length of the reinforcement, has at that point transverse sections, each of which is asymmetrical and of greater area than that of each adjacent transverse separating space.

Each asymmetrical portion of said at least one limb may advantageously have substantially the shape of a saw tooth comprising two tooth edges which each have a straight or curved profile and which are joined together at one pointed or rounded tooth end, such that said at least one part of the reinforcement is substantially in the shape of a saw-tooth of which the teeth are inclined on the same side, each asymmetrical limb preferably having substantially the shape of a comma, of which one of said tooth edges is curved in a convex manner and of which the other tooth edge is substantially straight or curved in a concave manner.

It is noteworthy that this asymmetrical geometry of the transverse sections located on said or each limb permits the profiled element incorporating said reinforcement covered by flexible coating material, on the one hand, to open by the creation of a radius and, on the other hand, to have improved operation when mounted on/dismantled from the rebate of the frame, by optimizing its rigidity. More specifically, this asymmetrical geometry means that the rigid thermoplastic material which is used for the reinforcement may be present in a greater quantity (i.e. with a greater mass) than in reinforcements of the prior art.

It should also be noted that this asymmetrical geometry achieves an improved capacity for bending of the profiled element incorporating the reinforcement as the flexible coating filling said transverse spaces is lengthened more easily proportionally to its height relative to the neutral axis of the profiled element.

It should also be noted that said transverse sections of the limb(s) forming said saw-tooth space may have a uniform or even gradual incline (i.e. progressive, namely more and more pronounced in one direction of the reinforcement).

Advantageously, a reinforcement according to the invention may be made of at least one rigid thermoplastic material capable of being extruded and having a Young's modulus of between 1000 MPa and 10000 MPa as a function of the reinforcing fillers used, and preferably between 2000 MPa and 6000 MPa. Even more advantageously, said thermoplastic material may be based on at least one thermoplastic polymer (TP) which is, for example, selected from the group consisting of polypropylenes, polyamides, polyvinyl chlorides (PVC), polymethyl-methacrylates (PMMA), acrylonitrile butadiene-styrene (ABS) terpolymers and their composites, which is preferably a polypropylene reinforced by a filler, for example, selected from the group consisting of talc, hemp, wood, cork, glass fibers and their composites (the function of this filler being to increase the rigidity of the base material). It is noteworthy that other thermoplastic polymers are able to be used to produce a reinforcement according to the invention and that the choice of said polymers provides, in particular, a compromise between the cost and rigidity of the materials in question.

Also advantageously, said or each rib may be made of a thermoplastic material which is identical to or different from that of said transverse portions, and this material may be selected to be more flexible or more rigid than that of the portions depending on the rigidity thereof. The material of said or each rib may incorporate a reinforcing filler which is identical or different from that of the remainder of the reinforcement and at an identical or different rate (it is possible for example to provide for the or each rib a filler consisting of glass fibers or hemp at between 20 and 40% percentage by weight, the remainder of the reinforcement also able to be provided with a filler consisting of talc at between 20 and 40% percentage by weight).

According to a preferred embodiment of the invention, said at least one longitudinal portion has a substantially U-shaped cross section designed to serve as a grip for the profiled element and having two limbs of identical or different lengths which extend substantially at right angles from said top portion and which each incorporate said rib on their internal or external face.

It is noteworthy that the ribs thus respectively formed on said two U-shaped limbs may be symmetrical to one another relative to the U-shaped top portion or even asymmetrical relative to said top portion, said asymmetry being able to be selected according to the desired applications and/or according to the geometry of the rebate of the frame.

According to a first embodiment of the invention relative to said preferred embodiment, the reinforcement consists of a single said longitudinal portion of substantially U-shaped (or semi-S-shaped) cross section.

According to a second embodiment of the invention relative to said preferred embodiment, the reinforcement consists of two said longitudinal portions of substantially U-shaped cross section which extend mutually in the transverse direction such that the reinforcement has three limbs substantially parallel with one another, the lateral limb adjacent to the two limbs forming the grip, in turn, also optionally incorporating a so-called rib. According to this second embodiment, the reinforcement may advantageously have a substantially S-shaped cross section with three limbs of identical or different heights, said lateral limb optionally incorporating a so-called rib on one of its faces (i.e. on its internal face turned towards the two other limbs or even its opposing external face).

A profiled seal or profiled molding for a motor vehicle according to the invention comprises a thermoplastic reinforcement as defined above and at least one elastomer coating which is more flexible than said reinforcement and extruded thereon.

According to an embodiment of the invention, said profile essentially comprises in the case of a profiled seal:
a part forming the grip which is reinforced by the reinforcement for the mounting thereof on a rebate of a frame and of which the coating is produced in a flexible elastomeric material which is compatible with that of the reinforcement and which is preferably based on at least one rubber, such as an EPDM, or at least one thermoplastic elastomer (TPE) such as a styrene thermoplastic elastomer (a TPS, e.g. a SEBS) or thermoplastic vulcanizate (TPV, e.g. “Santoprene” or “Vegaprene”) or other TPE having similar modulus properties at 100% extension and resistance to rupture and
a flexible deformable seal part which is tubular or in the form of a lip which is produced in at least one elastomeric material (for example a TPE such as a TPV or a TPS or even a rubber such as an EPDM) which is preferably cellular and which extends said part forming the grip into one arm of the U-shape.

A further object of the present invention is to propose a method for the production of bendable and slotted thermoplastic reinforcements for profiled seals or profiled moldings in a motor vehicle, in particular a reinforcement such as defined above (i.e. for example with transverse sections connected together in said at least one limb by said rib) which makes it possible, in particular, to adjust at will the slotted patterns produced over the length of the reinforcement and, in the particular case of reinforcements with rib(s) according to the invention, depending on the application and the envisaged mounting, “controlling” the positioning and/or the geometry of the or each rib forming the neutral axis of the profiled element.

To this end, a method for the production of slotted reinforcements according to the invention comprises an extrusion of at least one thermoplastic material via a die formed between an extruder head and a receiving member for the material discharged from the head, which is provided with a hollow cavity designed to form directly said reinforcement, so that said material thus extruded progressively covers said receiving member, followed by a separation of said material from the receiving member.

It is noteworthy that this extrusion method should not be confused with calendering, which by definition involves the passage of material between two wheels or rotating cylinders, and this extrusion advantageously makes it possible to “control” the positioning and the shape of the neutral axis of the profiled element subsequently obtained.

It is also noteworthy that in the particular case of said reinforcement with rib(s) according to the invention, said top portion and said at least one limb of said or each portion provided with said rib are thus extruded in one piece.

According to a further feature of this method of the invention, the reinforcement thus comprising at least one longitudinal portion of substantially U-shaped or L-shaped cross section having a top portion and at least one limb extending from said top portion, said die may be formed by a fixed extruder head covering tangentially the periphery of a wheel which forms said receiving member and which rotates about its axis so that its periphery penetrates inside said head or is penetrated by said head so that the extruded material progressively covers said wheel periphery during its rotation, which periphery may have, firstly, at least one peripheral radial flank having a hollow cavity forming said at least one limb when covered by said material and, secondly, at least one circumferential edge having a hollow cavity forming said at least one top portion when covered.

As a variant, said die may be formed by a fixed extruder head tangentially covering the periphery of a track or of conveyor belt which forms said receiving member and of which the kinematics comprises a series of movements in translation and rotation about the two axes, so that the periphery of said track or said conveyor belt penetrates inside said head or is penetrated by said head so that the extruded material progressively covers said periphery during its kinematic movement, which periphery has, firstly, at least one peripheral radial flank having a hollow cavity forming said at least one limb when covered by said material and, secondly, a circumferential edge having a hollow cavity forming said at least one top portion when covered.

According to a first embodiment of this method of the invention common both to the wheel and to the track or conveyor belt to form the receiving member, said periphery of said member has a protruding shape which penetrates inside said head to obtain said or each rib on a specifically external face of said or each limb (i.e. on its face opposing said top portion of the reinforcement).

According to a second embodiment of this method, also common to said different geometries of the receiving member, said periphery of said member has a retracted shape, inside which said head penetrates, to obtain said or each rib on a specifically internal face of said or each limb (i.e. on its face turned towards said top portion of the reinforcement).

It is noteworthy that it is possible to use by way of a receiving member a further device which is technically equivalent to the wheel, the conveyor belt or aforementioned track, it being understood that the geometry of the reinforcement thus extruded may be implemented depending on the choice of said member.

It is also noteworthy that the aforementioned optionally asymmetrical geometry (for example in the shape of a comma) of the transverse sections of the reinforcement thus extruded on said at least one limb makes it possible to improve the separation and thus the extraction of said reinforcement relative to the wheel periphery, in comparison with reinforcements with limbs which are generally triangular but which are symmetrical relative to their free end.

Advantageously and as indicated above, it is noteworthy in a general manner that this method of the invention whatever the form of reinforcement obtained is without a post-forming step of said at least one extruded thermoplastic material, such as a cutting, sawing or notching step.

Further features, advantages and details of the present invention will emerge from reading the following description of several embodiments of the invention given by way of illustrative and non-limiting example, and produced with reference to the accompanying drawings, in which:

FIG. 1 is a cross-sectional view along the plane I-I of FIG. 4 of a profiled seal of the door seal type for a motor vehicle incorporating in its grip a U-shaped reinforcement according to the invention with transverse sections connected together by two lateral ribs, said cutting plane passing through a transverse portion,

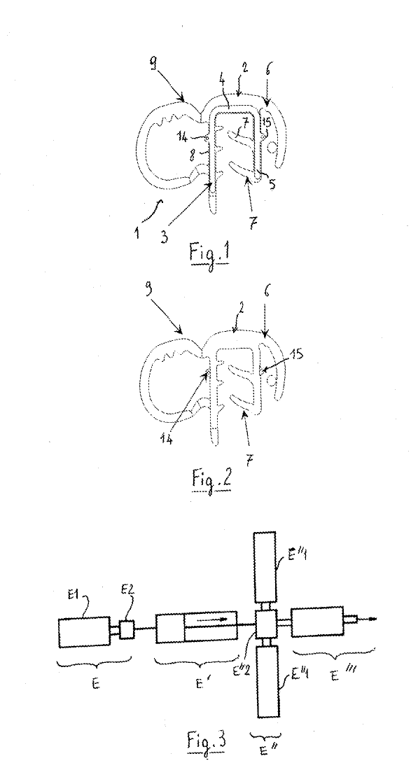

FIG. 2 is a cross-sectional view of the reinforcement of FIG. 1 along the plane II-II of FIG. 4, said sectional plane being located between two transverse sections,

FIG. 3 is a block diagram showing the principal steps of a method for the production of a profiled element according to the invention as that of FIG. 1 with an extrusion of the thermoplastic reinforcement and over-extrusion of a coating for covering said reinforcement,

FIG. 4 is a partial schematic view from the side and in perspective of a U-shaped thermoplastic reinforcement with lateral ribs according to an embodiment of the invention,

FIG. 5 is a partial schematic view from the side and in perspective from a different angle from the reinforcement of FIG. 4,

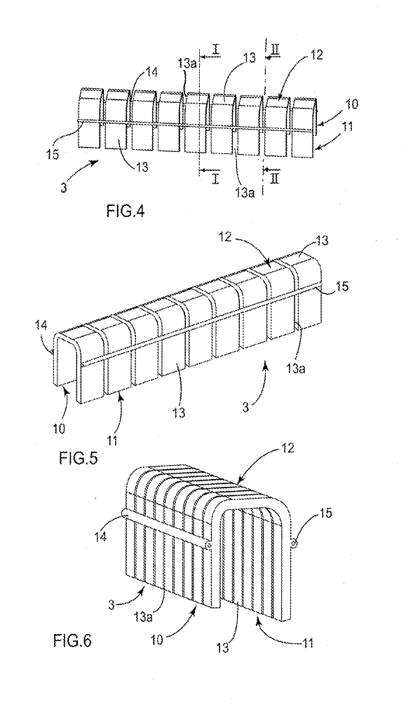

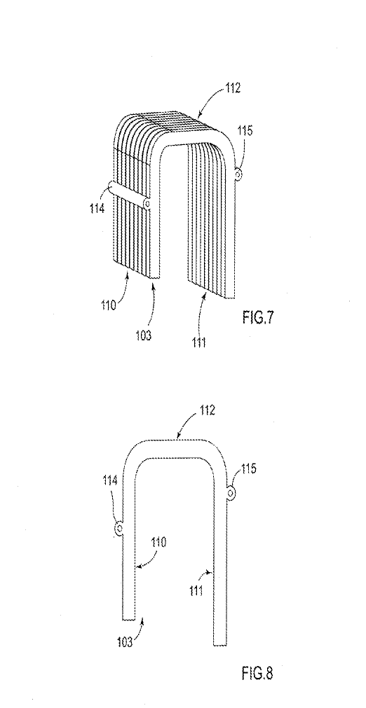

FIG. 6 is a partial schematic view both from the front and in perspective of the reinforcement of FIGS. 4 and 5,

FIG. 7 is a partial schematic view both from the front and perspective of a U-shaped reinforcement according to a variant of FIGS. 4 to 6,

FIG. 8 is a front view of the reinforcement of FIG. 7,

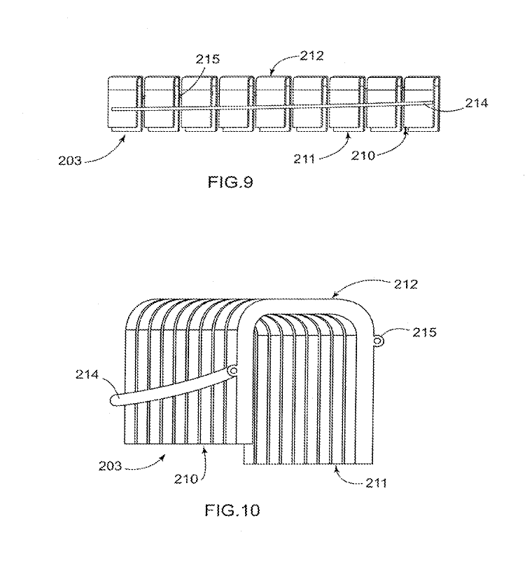

FIG. 9 is a partial schematic view from the side and slightly in perspective of a U-shaped reinforcement according to a further variant of FIGS. 4 to 6,

FIG. 10 is a partial schematic view from the side and in perspective from a different angle from the reinforcement of FIG. 9,

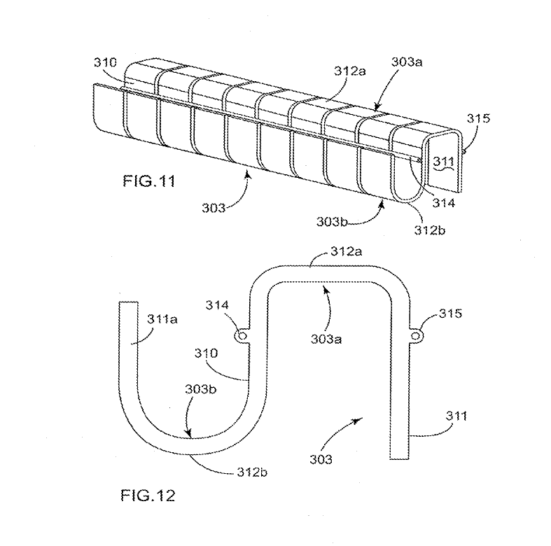

FIG. 11 is a partial schematic view from the side and in perspective of an S-shaped reinforcement with lateral ribs according to an embodiment of the invention,

FIG. 12 is a front view of the reinforcement of FIG. 11,

FIG. 13 is a partial schematic view from the side and in perspective of an S-shaped reinforcement with lateral ribs according to a variant of FIGS. 11 to 12,

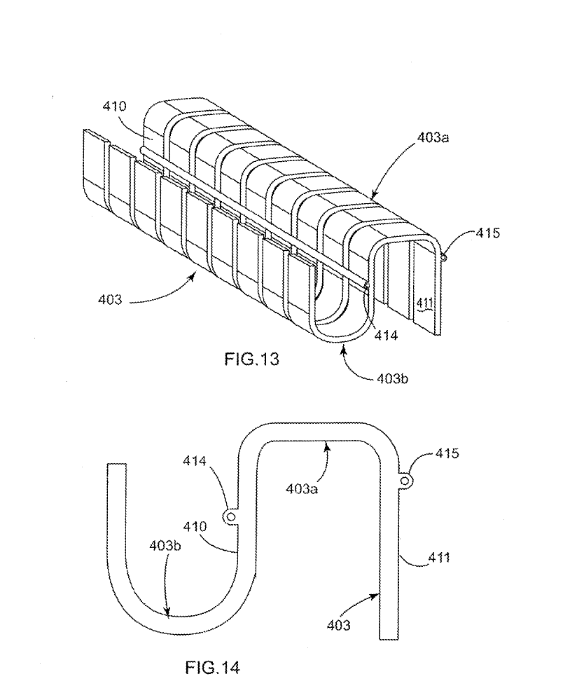

FIG. 14 is a front view of the reinforcement of FIG. 13,

FIG. 15 is a partial schematic view from below and in perspective of an S-shaped reinforcement with lateral ribs according to a further variant of FIGS. 11 and 12,

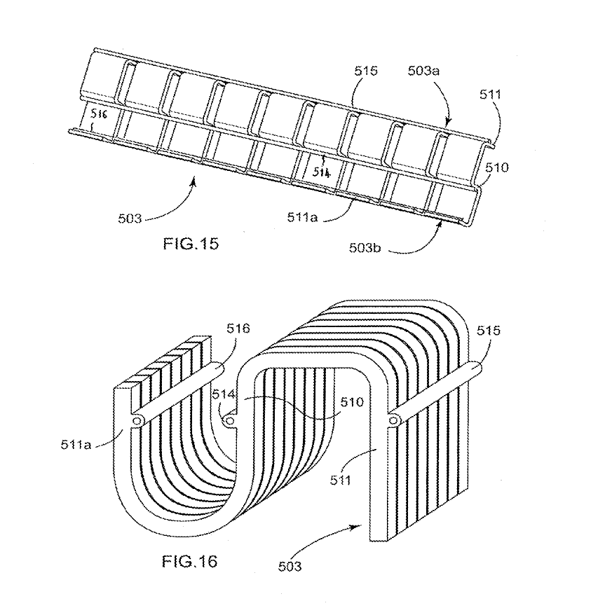

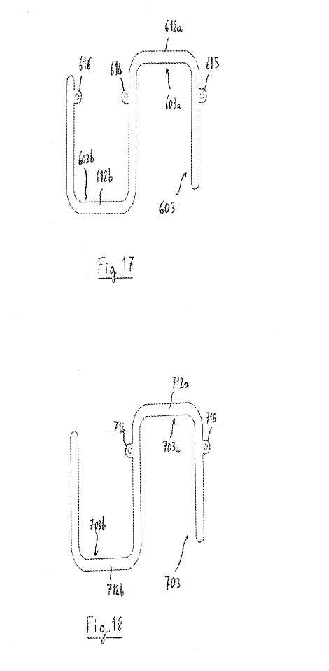

FIG. 16 is a partial schematic view from the side and in perspective of the reinforcement of FIG. 15,

FIG. 17 is a front schematic view of an S-shaped reinforcement with lateral ribs according to a further variant of FIGS. 11 and 12,

FIG. 18 is a front schematic view of an S-shaped reinforcement with lateral ribs according to a further variant of FIGS. 11 and 12,

FIG. 19 is a schematic lateral view of an extruder head receiving a rotating wheel provided with a peripheral hollow cavity and cooperating with said head to form an extrusion die able to be used for implementing the manufacturing method for reinforcements according to the invention,

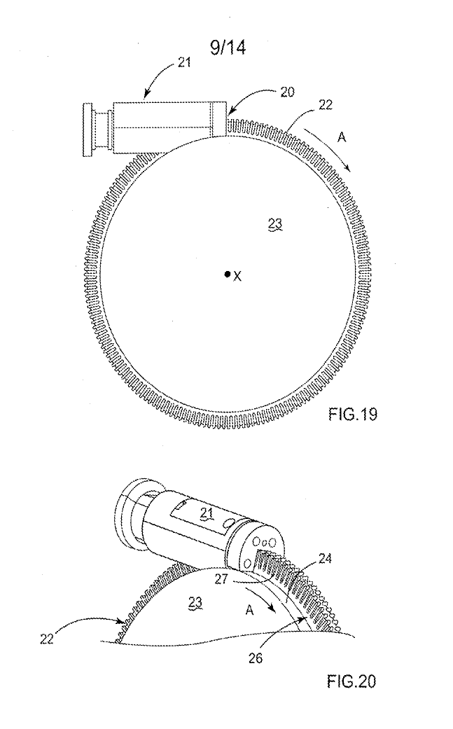

FIG. 20 is a partial schematic view in lateral perspective showing in enlargement the rotation of the wheel of FIG. 19 inside the extruder head,

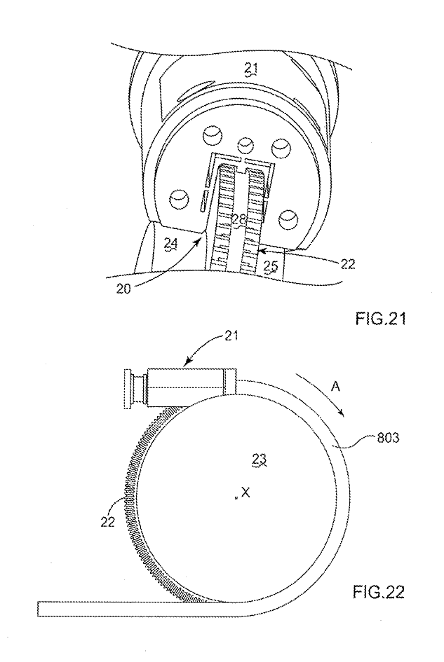

FIG. 21 is a partial front schematic view and in perspective, showing in enlargement the geometry of the extrusion die illustrated in FIGS. 19 and 20, which is defined by the space existing between the inside of the extruder head and the cavity of the wheel,

FIG. 22 is a lateral schematic view of the extruder head receiving the rotating wheel according to FIGS. 19 to 21, the peripheral cavity of said wheel being progressively covered by the extruded material designed to form the reinforcement,

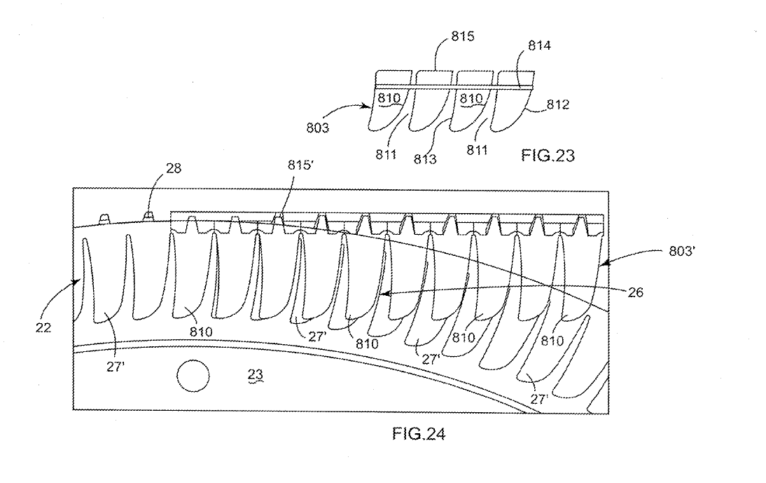

FIG. 23 is a partial lateral schematic view of a further U-shaped reinforcement according to the invention with asymmetrical limbs, able to be obtained by a method according to the invention,

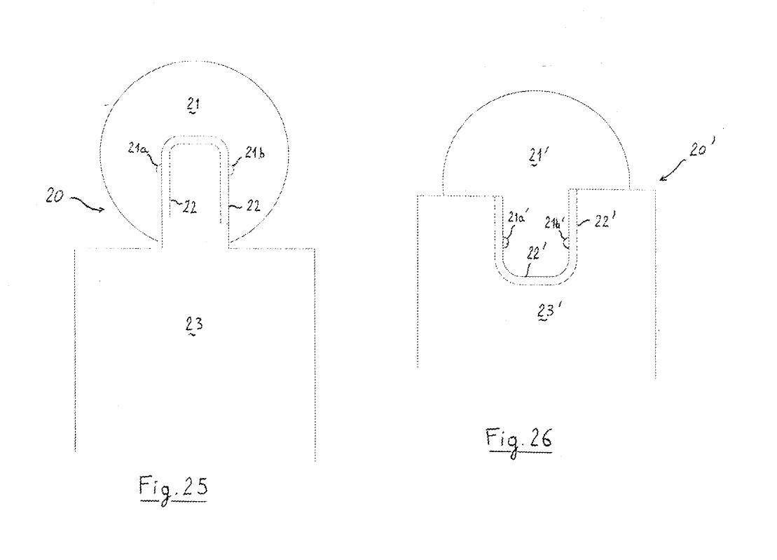

FIG. 24 is a partial lateral view illustrating the separation of an extruded reinforcement according to a variant of FIG. 23 with the peripheral cavity of the rotating wheel of FIGS. 19 to 22,

FIG. 25 is a partial schematic front view illustrating the geometry protruding from the wheel periphery inside the extruder head according to FIG. 21, to obtain a reinforcement with external ribs of the type of that of FIGS. 4 to 6,

FIG. 26 is a partial schematic front view illustrating, according to a variant of FIG. 25, the geometry protruding from the extruder head inside the wheel periphery according to FIG. 21 to obtain a reinforcement with internal ribs,

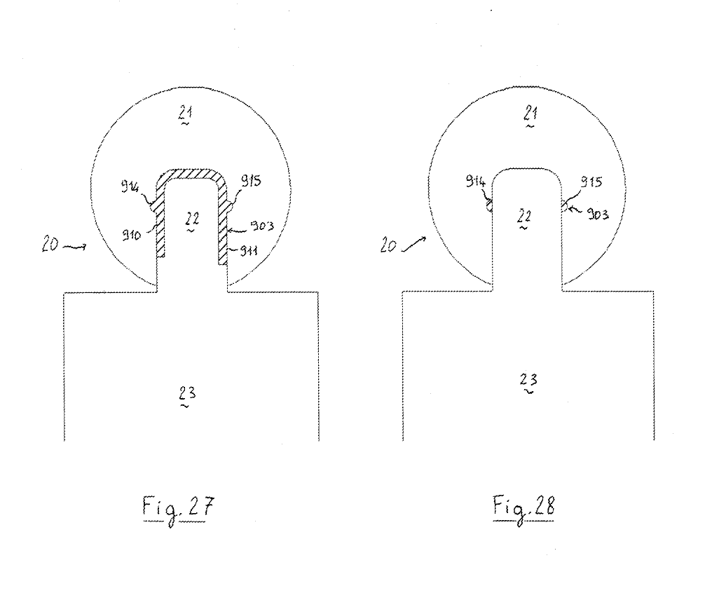

FIGS. 27 and 28 are schematic cross sectional views of the die of FIG. 25, showing the extrusion of the reinforcement respectively through a ribbed transverse section thereof and between its consecutive transverse portions connected by said external ribs, and

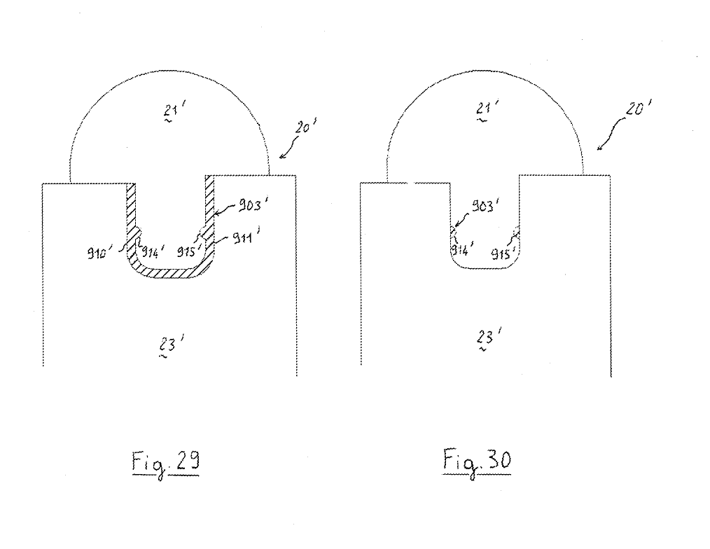

FIGS. 29 and 30 are two schematic views in cross section of the die of FIG. 26 showing the extrusion of the reinforcement respectively through a ribbed transverse section thereof and between its consecutive transverse portions connected by said internal ribs.

The profiled seal 1 illustrated in FIGS. 1 and 2 is designed to form a seal of a side opening of a motor vehicle, providing the seal between said opening and the bodywork of the vehicle and it comprises:
a grip 2 made of a flexible elastomeric material (for example based on at least one TPE such as a TPS or a TPV or at least one rubber, such as an EPDM) which is reinforced by a rigid thermoplastic U-shaped reinforcement 3 for the mounting thereof on a rebate of a frame and which is extended at the junction between the central portion 4 and an arm 5 of the U-shape by a “cosmetic” lip 6 also produced from a flexible thermoplastic material and folded back along the arm 5, said grip comprising, on the respective internal faces of its arms 5 and 8, lips 7 for hooking onto the die, and
a flexible and deformable sealing tube 9 (advantageously replaced by a lip in some profiled elements) which extends the grip 2 at the junction between the central portion 4 and the other arm 8 of the U-shape which is produced in an elastomeric material, for example a cellular material (for example in at least one TPE such as a TPS or a TPV, or in at least one rubber such as an EPDM).

More specifically and as visible in the example of FIGS. 4 to 6, the U-shaped reinforcement 3 has two limbs 10 and 11 extending from a top portion 12 and it consists of a discontinuous series of transverse U-shaped sections 13 which are regularly spaced apart over the length of the reinforcement 3 by spaces or transverse slots 13a and which are solely connected together in said two limbs 10 and 11 by two longitudinal ribs 14 and 15 respectively formed thereon and designed to form a neutral axis for the profiled element 1.

The profiled seals 1 or profiled trim moldings according to the invention, such as those of FIG. 1, are advantageously obtained by a method of extruding the rigid thermoplastic reinforcement 3 with an over-extrusion of the remainder of the profiled element 1 forming the flexible coating of the reinforcement 3, as illustrated in FIG. 3. An initial extrusion step E of the reinforcement 3 may be seen (carried out in an extruder head E1 provided with a die E2, of which the structure and the operation will be disclosed hereinafter), followed by a cooling step E′ of the reinforcement 3 thus extruded, then an over-extrusion E″ of a flexible thermoplastic coating in contact with said extruded reinforcement 3 and cooled via an extruder head E″1 provided with a die E″2 and finally a calibration E′″ of the extruded profiled element 1 thus obtained.

In addition, it is possible to conceive of an improvement of the behavior of the coating on the reinforcement 3 by incorporating within the manufacturing method, before insertion into the coating device, a step of reactivating the surface of the reinforcement 3 (for example by heating, plasma treatment or electrical bombardment of the surface of the “corona” type, for example) or even surface-coating (for example by spraying, drop-by-drop applied by brush) or even over-extrusion of a compatibilizing intermediate layer between the material(s) of the reinforcement 3 and the coating material(s).

The thermoplastic reinforcement 3 illustrated in FIGS. 4 to 18 is thus obtained exclusively by the extrusion of a rigid thermoplastic material, such as a material based on polypropylene, by way of preferred example.

It is possible, for example, to use a polypropylene reinforced with talc at a percentage by weight which is able to vary from 0 to 50% and preferably between 30% and 40%. By way of non-limiting example, it is possible to use 30% talc with a Young's modulus obtained for the reinforcement 3 of approximately 2300 MPa or even 40% talc with, in this case, a Young's modulus for the reinforcement 3 of approximately 4000 MPa.

As a variant, it is possible to use advantageously a polypropylene reinforced by short and/or long glass fibers at a percentage by weight of glass fibers which is able to vary from 0 to 60% and preferably between 30% and 40%, with a Young's modulus obtained for the reinforcement 3 of approximately 5900 MPa for 30% long glass fibers and approximately 6600 MPa for 30% short glass fibers.

According to further variants of the invention, it is possible to use a polypropylene reinforced by short and/or long hemp fibers at a percentage by weight of hemp which is able to vary from 0 to 40% or even reinforced by a mixture of talc and glass fibers, by way of non-limiting example.

As visible in FIGS. 4 to 6, the reinforcement 3 has in this example two limbs 10 and 11 of different heights which provide it with an asymmetrical geometry relative to the top portion 12 (which is substantially flat) and the ribs 14 and 15 extruded in one piece with the limbs 10 and 11 are located at the same height on the external face thereof (in this example in the upper half of each limb 10, 11). Each of said ribs 14 and 15 thus forms a neutral axis for the profiled element incorporating the reinforcement 3. It is possible to see in said figures that the transverse spaces 13a are reduced by being partially interstitial in the longitudinal direction relative to the transverse sections 13. Still in this illustrated example, each rib 14, 15 has a rectilinear shape parallel to the top portion 12, by being substantially cylindrical and hollow over its length, an anti-elongation thread, for example made of glass fiber (not shown), being advantageously inserted therein.

The reinforcement 103 of FIGS. 7 and 8 is solely distinguished from that of FIGS. 4 to 6, in that the two ribs 114 and 115 which it incorporates on its limbs 110 and 111, which are also of different heights, are formed at different heights on the external faces thereof (said ribs 114 and 115 are also rectilinear and parallel to the top portion 112).

The reinforcement 203 of the FIGS. 9 and 10 is distinguished solely from that of FIGS. 7 and 8 in that the two ribs 214 and 215 which it incorporates on its limbs 210 and 211, which are still of different heights, are not parallel to the top portion 212 but generally oblique relative thereto, which they both approach progressively toward a given end of the reinforcement 203 such that each rib 214, 215 is continuously curved (in this example, it has an increasing angle toward the top portion 212). Also in FIGS. 9 and 10, it is seen that said ribs 214 and 215 extend at different heights on the limbs 210 and 211 as in FIGS. 7 and 8.

The reinforcement 303 of FIGS. 11 and 12 is distinguished from that of FIGS. 4 to 6, in that it transversely extends a longitudinal U-shaped portion 303a with a substantially planar top portion 312a similar to the reinforcement 3 (this portion 303a being designed to serve as a grip for the profiled element incorporating the reinforcement 303 with the purpose of the mounting thereof on a die), on the limbs 310 and 311 thereof two external ribs 314 and 315 being respectively formed at the same given height by a further longitudinal U-shaped portion 303b which forms an S-shaped space with the preceding portion. The portion 303b has in this example an external limb 311a parallel to the limbs 310 and 311 and a top portion 312b of rounded shape which opposes the top portion 312a of the portion 303a such that the respective internal cavities of said portions 303a and 303b are reversed.

The S-shaped reinforcement 403 of FIGS. 13 and 14 is distinguished solely from that of FIGS. 11 and 12 in that its two ribs 414 and 415 are formed at different heights on the external faces of the respective limbs 410 and 411 of the portion 403a designed to serve as a grip for the profiled element, the other reversed portion 403b being similar to the portion 303b.

The S-shaped reinforcement 503 of FIGS. 15 and 16 is solely distinguished from that of FIGS. 11 and 12 in that its portion 503b, extending transversely the portion 503a forming the grip and terminated by an external limb 511a parallel to the limbs 510 and 511 of the portion 503a, is such that this limb 511a is also ribbed on its internal face opposite the two others 510 and 511 via a third rib 516 (formed in this example at the same height as the two ribs 514 and 515 of the portion 503a) so as to form also a neutral axis for the profiled element incorporating said reinforcement 503.

The S-shaped reinforcement 603 with three ribs 614, 615 and 616 of FIG. 17 is solely distinguished from that of FIGS. 15 and 16 in that its portion 603b extending the portion 603a forming the grip has a substantially planar top portion 612b, like the top portion 612a of the portion 603a.

The reinforcement 703 with two ribs 714 and 715 of FIG. 18 is solely distinguished from that of FIGS. 11 and 12 in that its portion 703b extending the portion 703a forming the grip also has a substantially planar top portion 712b, like the top portion 712a of the portion 703a.

The reinforcement 803 of FIG. 23 is of U-shaped cross section with two ribs 814 symmetrical to one another (only one is visible in this figure) in the case of FIGS. 4 to 6. However, this reinforcement 803 has in its two parallel limbs a series of pairs of lateral asymmetrical limbs 810 laterally opposite one another which are separated from one another by transverse slots 811 and which are profiled toward the respective free edges of the limbs (i.e. each limb 810 being tapered with a longitudinal width and/or transverse thickness continuously decreasing from top to bottom), having in this example substantially the shape of a comma at the edges 812 and 813, continuously curved between two adjacent slots 811 (said edges 812 and 813 being preferably convex and concave) and as far as the rounded free end. In the example of FIG. 23, each limb 810 has a width which decreases continuously towards its free end, specifically as an alternative or in addition to its width, it is the thickness which could decrease in this direction. It may be seen that the slots 811 each have a markedly smaller area than that of each adjacent limb 810.

As will be disclosed here with reference to FIGS. 19 to 22, 24, 25, 27 and 28, the aforementioned top portions, limbs and ribs in relation to FIGS. 4 to 18 and 23 are formed in one piece by being exclusively extruded (i.e. without calendering and without subsequent cutting, notching or sawing operations, in contrast to the prior art).

FIGS. 19 to 22 and 25, 27, 28 illustrate the structure and operation of a specific extrusion die 20 which may be generally used to produce reinforcements including the reinforcements 3 to 803 with ribs 14 to 814, 15 to 715, 516 and 616 but also any other bendable and slotted thermoplastic reinforcements of, for example, U-shaped section, of which the limbs may be connected together in the region of the top portion of the reinforcement (which top portion may be solid or slotted) and may for example (see FIGS. 23 and 24) each have a multitude of limbs which are each, selectively:
symmetrical or asymmetrical,
straight (i.e. of a width in the longitudinal direction and of a thickness in the transverse direction which are both uniform) or tapered (i.e. of a width and/or thickness which decrease(s) from the top portion to the free end of each limb) and
said limbs being optionally connected together by a rib as those mentioned with reference to FIGS. 4 to 18 and 23.

FIGS. 20, 21 and 25, 27, 28 show schematically the geometry of the extrusion die 20 of the U-shaped profile which is, in particular, usable to obtain a U-shaped reinforcement 803 as that of FIGS. 23 and 24 which is visible during the course of extrusion in FIG. 22.

Said die 20 is formed by a fixed extruder head 21 tangentially covering the periphery 22 of a wheel 23 which is driven in rotation about its axis of symmetry X in the direction of the arrow A and is designed to receive in its periphery 22 the thermoplastic material (for example reinforced polypropylene) discharged from the head 21, so that said periphery 22 penetrates the inside of the head 21 and then is discharged from said head covered by the extruded material 803. More specifically and as visible in FIGS. 21 and 25, the wheel periphery 22 is connected to the remainder of the wheel 23 by two circumferential shoulders 24 and 25 which are symmetrical to one another relative to said periphery 22 and which are surmounted by the exterior of the extruder head 21.

The wheel periphery 22 is provided with hollow cavities designed to form directly the reinforcement 803 and this periphery 22 comprises, more specifically:
two peripheral radial flanks 26 respectively having two identical cavities of teeth 27 designed to form the limbs 810 and slots 811 when covered, and
a circumferential peripheral top portion 28 having a hollow cavity designed to form the top portion 815, 815′ when covered.

For the purposes of simplification of the FIGS. 19, 20 and 22, the precisely asymmetrical shape of the hollow teeth 27 formed on the radial flanks 26 of the wheel periphery 22 has not been shown in the figures, it being understood that this asymmetrical form is, for example, that illustrated in FIG. 24, with cavities 27′ in the shape of commas designed to form the reinforcement 803′.

As indicated above and visible in said FIG. 24, it is noteworthy that this asymmetrical geometry of the limbs 810 has, in particular, the advantage of improving the separation of said extruded reinforcement 803, 803′ relative to the wheel periphery 22, in comparison with reinforcements generally having triangular or trapezoidal limbs but which are symmetrical relative to their free end (i.e. limbs of isosceles triangle shape with a pointed or rounded or flat top portion).

In contrast to the die 20 of FIGS. 25, 27 and 28 where the wheel periphery 22 penetrates during its rotation inside the fixed extruder head 21 to obtain transverse sections of the reinforcement 903 connected together by ribs 914 and 915 on the respective external faces of the limbs 910 and 911 (said ribs 914 and 915, visible in FIGS. 27 and 28 which relate respectively to the sectional planes I-I and II-II of FIG. 4, being obtained by corresponding cavities 21a and 21b visible in FIG. 25, and formed inside the head 21), the die 20′ of the FIGS. 26, 29 and 30 is such that the fixed extruder head 21′ penetrates inside the periphery 22′ of the wheel 23′ of retracted shape during the rotation thereof, to obtain two ribs 914′ and 915′ on the respective internal faces of the two limbs 910′ and 911′ of the reinforcement 903′ (said ribs 914′ and 915′ visible in FIGS. 29 and 30 being obtained by corresponding cavities 21a′ and 21b′ visible in FIG. 26 and formed inside the head 21).

As indicated above, it is noteworthy that this arrangement protruding from the extruder head 21′ inside the periphery 22′ of the wheel 23′ may be transposed to a receiving member other than a wheel, for example of the track or conveyor belt type, by way of non-limiting example, to obtain an extruded reinforcement of which the or each rib designed to form a neutral axis for the profiled element incorporating said reinforcement, is located on the internal face of the or each limb of the reinforcement as a variant of the reinforcements with external ribs illustrated in FIGS. 4 to 18.

1. A bendable thermoplastic reinforcement for a profiled seal or profiled molding in a motor vehicle, the reinforcement comprising at least one longitudinal portion of substantially U-shaped or L-shaped cross section having a top portion and at least one limb extending from said top portion, said reinforcement comprising over its length a discontinuous series of transverse sections connected together by longitudinal connecting elements, characterized in that said connecting elements comprise a generally longitudinal rib which is formed in one piece with said transverse sections in said or each limb and which is designed to form a neutral axis for the profiled seal or molding.

2. The reinforcement as claimed in claim 1, wherein said reinforcement is exclusively extruded, said or each rib being directly extruded.

3. The reinforcement as claimed in claim 1 said transverse sections are separated in pairs from one another by transverse spaces passing from one free lateral edge to the other of the reinforcement and are exclusively connected to one another by said or each rib, and in that at said top portion of said at least one longitudinal portion, said transverse sections are not connected together or are connected via interstitial webs of reduced thickness.

4. The reinforcement as claimed in claim 1, wherein said or each rib extends continuously along said transverse sections, such that on said at least one limb only one ordinate transverse to said rib corresponds to one given longitudinal abscissa of said rib.

5. The reinforcement as claimed in claim 4, wherein said or each rib is rectilinear or in the form of a broken line and is substantially parallel with said top portion or inclined relative thereto.

6. The reinforcement as claimed in claim 4, wherein said or each rib is curved, either by being progressively inclined toward said top portion, or undulated by alternately moving away and then approaching said top portion.

7. The reinforcement as claimed in claim 1, wherein said at least one limb having an internal face and an external face, wherein said or each rib forms an overthickness on said internal or external face of reduced transverse height relative to that of said limb.

8. The reinforcement as claimed in claim 1, wherein said or each rib is hollow over its length, an anti-elongation thread being inserted therein to stiffen the reinforcement in the longitudinal direction.

9. The reinforcement as claimed in claim 1, wherein said or each rib is made of a thermoplastic material which is identical to or different from that of said transverse sections.

10. The reinforcement as claimed in claim 1, wherein said at least one longitudinal portion has a substantially U-shaped cross section designed to serve as a grip for the profiled element and having two limbs of identical or different lengths which extend substantially at right angles from said top portion and which each incorporate said rib on their internal or external face.

11. The reinforcement as claimed in claim 10, wherein said reinforcement consists of a single said longitudinal portion of substantially U-shaped cross section.

12. The reinforcement as claimed in claim 10, wherein said consists of two said longitudinal portions of substantially U-shaped cross section which extend mutually in the transverse direction such that the reinforcement has three limbs substantially parallel with one another, the lateral limb adjacent to the two limbs forming the grip in turn also optionally incorporating one said rib.

13. The reinforcement as claimed in claim 12, wherein said reinforcement has a substantially S-shaped cross section with three limbs of identical or different heights, said lateral limb incorporating one said rib on one of its faces.

14. The reinforcement as claimed in claim 1, wherein said transverse sections are separated in pairs from one another by transverse spaces into said at least one limb which, over at least one part of the length of the reinforcement, has each of its transverse portions which is asymmetrical and of greater area than that of each adjacent space.

15. The reinforcement as claimed in claim 14, wherein each asymmetrical section has on said at least one limb substantially the shape of a saw tooth comprising two tooth edges which each have a straight or curved profile and which are joined together at one pointed or rounded tooth end, such that said at least one part of the reinforcement is substantially in the shape of a saw tooth of which the teeth are inclined on a same side, each asymmetrical limb having substantially the shape of a comma, of which one of said tooth edges is curved in a convex manner and of which the other tooth edge is substantially straight or curved in a concave manner.

16. A profiled seal or profiled molding for a motor vehicle comprising a thermoplastic reinforcement and at least one elastomeric coating which is more flexible than said reinforcement and extruded thereon, wherein the reinforcement is as defined in claim 1.

17. A profiled seal as claimed in claim 16, wherein the profiled seal comprises:
a part forming a grip which is reinforced by said reinforcement for the mounting thereof on a rebate of a frame and of which the coating is made of an elastomeric material which is compatible with that of the reinforcement, said material preferably being based on at least one thermoplastic elastomer (TPE) or a thermoplastic vulcanizate (TPV), or at least one rubber and
a flexible and deformable seal part which is tubular or in the form of a lip which is made of an elastomeric material which is cellular and based on at least one TPE, or a TPV or at least one rubber, and which extends said part forming the grip in one arm of the U-shape.

18. A method for the production of bendable and slotted thermoplastic reinforcements for profiled seals or profiled moldings in a motor vehicle, in particular a reinforcement as claimed in claim 1, wherein the method comprises an extrusion of at least one thermoplastic material via a die formed between an extruder head and a receiving member for the material being discharged from said head, which receiving member is provided with a hollow cavity configured to form directly said reinforcement, so that said material thus extruded progressively covers said receiving member, followed by a separation of said material from the receiving member.

19. The method as claimed in claim 18, the reinforcement comprising at least one longitudinal portion of substantially U-shaped or L-shaped cross section having a top portion and at least one limb extending from said top portion, characterized in that said die is formed by a fixed extruder head covering tangentially the periphery of a wheel which forms said receiving member and which rotates about its axis (X) so that its periphery penetrates inside said head or is penetrated by said head so that the extruded material progressively covers said wheel periphery during its rotation, which periphery has, firstly, at least one peripheral radial flank having a hollow cavity forming said at least one limb when covered by said material and, secondly, at least one circumferential edge having a hollow cavity forming said at least one top portion when covered.

20. The method as claimed in claim 18, wherein said die is formed by a fixed extruder head tangentially covering the periphery of a track or conveyor belt which forms said receiving member and of which the kinematics comprises a series of movements in translation and rotation about two axes, so that the periphery of said track or of said conveyor belt penetrates inside said head or is penetrated by said head so that the extruded material progressively covers said periphery during its kinematic movement, which periphery has, firstly, at least one peripheral radial flank having a hollow cavity forming said at least one limb when covered by said material and, secondly, a circumferential edge having a hollow cavity forming said at least one top portion when covered.

21. The method as claimed in claim 19, wherein said periphery of said receiving member has a protruding shape which penetrates inside said head, to obtain said or each rib on an external face of said or each limb.

22. The method as claimed in claim 19, wherein said periphery of said receiving member has a retracted shape, inside which said head penetrates to obtain said or each rib on an internal face of said or each limb.

23. The method as claimed in claim 18, wherein said method is without a post-forming step of said at least one extruded thermoplastic material.
